(19) United States
(12) Patent Application Publication
(10) Pub. No.: US 2023/0163319 A1
(43) Pub. Date: May 25, 2023

(54) CATALYST, ELECTRODE, MEMBRANE ELECTRODE ASSEMBLY, FUEL CELL, AND METHOD FOR MANUFACTURING CATALYST

(71) Applicant: TOYOTA BOSHOKU KABUSHIKI KAISHA, Aichi (JP)

(72) Inventors: Hiroshi YANO, Aichi (JP); Kouta IWASAKI, Aichi (JP)

(73) Assignee: TOYOTA BOSHOKU KABUSHIKI KAISHA, Aichi (JP)

(21) Appl. No.: 17/988,475

(22) Filed: Nov. 16, 2022

(30) Foreign Application Priority Data
Nov. 25, 2021 (JP) 2021-190765

(51) Int. Cl. H01M 4/92; H01M 8/1004

(52) U.S. Cl. CPC H01M 4/926; H01M 8/1004

(57) ABSTRACT

A catalyst including: a carbon support doped with a nitrogen atom and a first transition metal atom; and a plurality of fine particles containing a noble metal and supported on the carbon support. The fine particles have an average particle size of 0.8 nm or more and 1.5 nm or less.

### CROSS-REFERENCE TO RELATED APPLICATION

This application is based on and claims the priority of Japanese Patent Application No. 2021-190765 filed on Nov. 25, 2021, the entire contents of which are incorporated herein by reference.

### BACKGROUND OF THE INVENTION

### (1) Field of the Invention

The present disclosure relates to a catalyst, an electrode, a membrane electrode assembly, a fuel cell, and a method for manufacturing a catalyst.

### (2) Description of Related Art

Metal particles having a nanometer size exhibit specific properties that are not observed in a bulk state, such as color development due to plasma vibration, an increase in catalytic activity, and a decrease in melting point. Applied research utilizing respective characteristics has been actively conducted in a wide variety of fields. Methods for preparing such metal particles are roughly two approaches. One is a “top-down” method in which a bulk raw material is refined by mechanical pulverization or the like, which is typified by a “milling method” (See C. Suryanarayana, Progress in Materials Science, 2001, 46, 1-184). The other is a “bottom-up” method in which atoms or molecules are grown to a required size and constructed. Synthesis of metal nanoparticles has been mainly performed by the bottom-up method that is easier to control their size to an arbitrary size than the top-down method. Further, the bottom-up method can be classified into: a gas phase method (dry method) in which a synthesis reaction is performed by a physical approach such as a “sputtering method” or a “spray pyrolysis method” (see M. T. Swihart, Current Opinion in Colloid and Interface Science, 2003, 8, 127-133); and a liquid phase method (wet method) in which crystal nuclei are generated in a liquid phase in which metal ions are dissolved, and nuclear growth is promoted to synthesize nanoparticles, such as a “coprecipitation method”, a “sol-gel method”, a “microemulsion method”, or a “solvothermal method” (see B. L. Cushing, V. L. Kolesnichenko, C. J. O'Connor, Chem. Rev., 2004, 104, 3893-3946).

Characteristics of each approach will be described below.

The top-down method requires only one step of pulverizing a bulk metal to a nano size, which makes the operation easy. The most advantage of this approach is that fine particles having high crystallinity are obtained. On the other hand, as described above, this method involves a problem of quite difficulty in size control. Even if it is attempted to actually produce particles of a target size, the size distribution may be large, and the required specificity may not be obtained.

With regard to the bottom-up method, the gas phase method and the liquid phase method will be separately described below.

The gas phase method easily forms highly crystalline fine particles composed of several atoms. On the other hand, this approach has disadvantages of low productivity and unsuitable for industrial uses.

The liquid phase method can manufacture nanoparticles having a relatively uniform size, if a temperature distribution of a reaction field is made uniform. The liquid phase method provides sufficiently higher productivity than that of the gas phase method. On the other hand, in this method, a protective agent is often used in order to prevent aggregation of nanoparticles and secure dispersibility, in the synthesis process. Therefore, this approach involves finally removing the protective agent from surfaces of metal particles and thus requires a large number of steps and high cost for recovering and concentrating only the metal nanoparticles. Furthermore, this approach provides low crystallinity because the nanoparticles are synthesized at low temperatures. This causes a decrease in activity as a catalyst. This approach requires a heating step to increase crystallinity. As a result, in this approach, it is difficult to maintain the size distribution in the final heat treatment even when nanoparticles having the same size are prepared.

### SUMMARY OF THE INVENTION

For the above reason, a size of the metal nanoparticles that can be synthesized by the conventional technique is limited to, at most, about 1 nm. However, in consideration of the size effect, in other words, in order to obtain a larger specific surface area, it is more preferable to set the size to 1 nm or less, and it is ideal to prepare a metal catalyst composed of particles composed of several atoms, desirably a single atom. An important factor at this time is to reduce the size as much as possible while maintaining high crystallinity, and development of a novel approach that achieves both the advantages of the top-down method and the bottom-up method described above is desired.

The present disclosure has been made for solving at least a part of the above problems, and can be realized in the following forms.

The present inventors have intensively studied to solve the above problems. Specifically, a catalyst in which noble metal nanoparticles having a size of about several nanometers were supported on a specific carbon support has been produced by the bottom-up method, formed into an electrode, and subjected to a potential cycle in a predetermined potential range under an acidic environment. As a result, the present inventors have found that the supported noble metal was dissolved to be smaller than the original size, and, on the other hand, the dissolved noble metal ions were trapped, with a nitrogen atom or a metal atom of a carbon skeleton as a starting point, to form new fine particles. That is, the present inventors have found that a high-performance catalyst is obtained by self-forming metal particles in a sub-nano region (1 nm or less) by performing a potential cycle. The thus-produced catalyst can be applied to a wide range of fields such as electrode catalysts for polymer electrolyte fuel cells (PEFCs), batteries using metal catalysts, sensors, and electrolysis, and has extremely high industrial applicability.

In a general metal nanoparticle synthesis method, it is chemically and physically very difficult to prepare a nanoparticle catalyst having uniform distribution and a size of 1 nm or less, and this is a weak area also from the viewpoint of industrial productivity. However, when the catalyst is used as an electrode catalyst (for example, a fuel cell), it is predicted that, as the particle size decreases, the specific surface area increases and the catalytic ability (activity) is improved. As a problem, for example, when used for a fuel cell, nanoparticles highly dispersed and supported during a power generation reaction basically deteriorate on the support (aggregation and coarsening due to Ostwald ripening). The tendency is stronger because the smaller the particle, the larger the surface area and the larger the surface energy. That is, the activity of nanoparticles is in a trade-off relationship with durability. One object of the present disclosure is to solve this trade-off problem.

Means of the present disclosure will be described below.

[1] A catalyst including: a carbon support doped with a nitrogen atom and a first transition metal atom; and a plurality of fine particles containing a noble metal and supported on the carbon support, wherein the fine particles have an average particle size of 0.8 nm or more and 1.5 nm or less.

The catalyst of the present disclosure has high performance because sub-nanoparticles are formed upon application of a voltage having a potential cycle.

### BRIEF DESCRIPTION OF THE DRAWINGS

FIG. 1 is a conceptual diagram illustrating Ostwald ripening of Pt particles;

FIG. 2 is a conceptual diagram illustrating a mechanism for forming sub-nano size Pt particles;

FIG. 3 is a schematic diagram of an example of a polymer electrolyte fuel cell;

FIGS. 4A to 4D include TEM images of various carbon supports, in which FIG. 4A: a TEM image of GCB, FIG. 4B: a TEM image of MPC, FIG. 4C: a TEM image of PMF, and FIG. 4D: a TEM image of CB;

FIGS. 5A to 5D include TEM images of various carbon supports after Pt is loaded, in which FIG. 5A: a TEM image of Pt/GCB, FIG. 5B: a TEM image of Pt/MPC, FIG. 5C: a TEM image of Pt/PMF, and FIG. 5D: a TEM image of Pt/CB;

FIG. 6 is an explanatory diagram illustrating an example of a potential cycle waveform;

FIGS. 7A to 7C include TEM images of Pt/GCB and a graph showing a change in particle size distribution before and after potential cycle treatment, in which FIG. 7A: a TEM image before the potential cycle treatment, FIG. 7B: a TEM image after the potential cycle treatment, and FIG. 7C: a graph showing a change in particle size distribution before and after the potential cycle treatment.

FIGS. 8A to 8E include TEM images of Pt/PMF, a graph showing a change in particle size distribution, and the like before and after the potential cycle treatment, in which FIG. 8A: a TEM image before the potential cycle treatment, FIG. 8B: a TEM image after the potential cycle treatment, and FIG. 8C: a dark field image after the potential cycle treatment, FIG. 8D: a graph showing a change in particle size distribution before and after the potential cycle treatment, and FIG. 8E: a diagram illustrating results of energy dispersive X-ray analysis;

FIGS. 9A and 9B include graphs showing an effect of potential cycles on an electrochemical surface area (ECA) and mass activity (MAₖ) in an oxygen reduction reaction, in which FIG. 9A: a graph showing an electrochemical surface area (ECA), and FIG. 9B: a graph showing mass activity (MAₖ) for an oxygen reduction reaction;

FIGS. 10A to 10C are diagrams illustrating effects of a Pt supporting method, in which FIG. 10A: a TEM image and a particle size distribution graph of Pt/PMF prepared using the prior art, FIG. 1B: a TEM image and a particle size distribution graph of Pt/PMF prepared using a colloid method, and FIG. 10C: a graph showing a maintenance ratio of mass activity; and

FIG. 11 is an explanatory diagram illustrating a deterioration acceleration protocol that simulates a potential fluctuation with respect to a load response of a fuel cell vehicle (FCV) recommended by Fuel Cell Commercialization Conference of Japan (FCCJ).

### DETAILED DESCRIPTION OF PREFERRED EMBODIMENTS

Here, other examples of the present disclosure are presented.

[2] The catalyst according to [1], wherein the fine particles have a standard deviation value of 0% or more and 10% or less with respect to an average particle size value.

The catalyst of the present disclosure has small variations in size of fine particles and high performance.

[3] The catalyst according to [1] or [2], wherein, when the catalyst is used in a fuel cell, at least one of the fine particles is dissolved and made minute due to power generation, and new fine particles containing a noble metal are generated on the carbon support from metal ions generated by the dissolution.

[4] An electrode including the catalyst according to any one of [1] to [3].

The electrode of the present disclosure has high performance because sub-nanoparticles are formed upon application of a voltage having a potential cycle.

[5] A membrane electrode assembly including the electrode according to [4] on a surface of an electrolyte membrane.

The membrane electrode assembly of the present disclosure has high performance because sub-nanoparticles are formed upon application of a voltage having a potential cycle.

[6] A fuel cell including the catalyst according to any one of [1] to [3].

The fuel cell of the present disclosure has high performance because sub-nanoparticles are formed upon application of a voltage having a potential cycle.

[7] A catalyst including: a carbon support doped with a nitrogen atom and a first transition metal atom; and a plurality of fine particles containing a noble metal and supported on the carbon support, wherein

the fine particles include particles having a size of less than 0.8 nm.

The catalyst of the present disclosure contains sub-nanoparticles and has high performance.

[8] The catalyst according to [7], wherein the fine particles have at least one peak at less than 0.8 nm in a particle size distribution map.

The catalyst of the present disclosure contains sub-nanoparticles and has high performance.

[9] A catalyst obtained by: applying, under an acidic environment, a voltage having a potential cycle to a composite in which a plurality of raw material fine particles containing a noble metal are supported on a carbon support doped with a nitrogen atom and a first transition metal atom to dissolve and make minute at least one of the raw material fine particles; and generating new fine particles, on the carbon support, from metal ions generated by the dissolution.

The catalyst of the present disclosure has high performance because sub-nanoparticles are formed upon application of a voltage having a potential cycle.

[10] The catalyst according to [9], wherein the potential cycle is a cycle repeated between potentials of 0 V or more and 1.0 V or less based on a standard hydrogen electrode.

The catalyst of the present disclosure has high performance because sub-nanoparticles are formed upon application of a voltage having a specific potential cycle.

[11] An electrode including the catalyst according to any one of [7] to [10].

The electrode of the present disclosure contains sub-nanoparticles and has high performance.

[12] A membrane electrode assembly including the electrode according to [11] on a surface of an electrolyte membrane.

The membrane electrode assembly of the present disclosure contains sub-nanoparticles and has high performance.

[13] A fuel cell including the catalyst according to any one of [7] to [10].

The fuel cell of the present disclosure contains sub-nanoparticles and has high performance.

[14] A method for manufacturing a catalyst, including: applying, under an acidic environment, a voltage having a potential cycle to a composite in which a plurality of raw material fine particles containing a noble metal are supported on a carbon support doped with a nitrogen atom and a first transition metal atom to dissolve and make minute at least one of the raw material fine particles; and generating new fine particles, on the carbon support, from metal ions generated by the dissolution.

In the manufacture method of the present disclosure, sub-nanoparticles are formed, and a high-performance catalyst can be manufactured.

[15] The method for manufacturing a catalyst according to [14], wherein the potential cycle is a cycle repeated between potentials of 0 V or more and 1.0 V or less based on a standard hydrogen electrode.

In the manufacture method of the present disclosure, sub-nanoparticles are efficiently formed, and a high-performance catalyst can be manufactured.

Hereinafter, the present disclosure will be described in detail. In addition, a phrase about a numerical range using the word “to” includes a lower limit value and an upper limit value unless otherwise specified. For example, the phrase “10 to 20” includes both the lower limit “10” and the upper limit “20”. That is, the phrase “10 to 20” has the same meaning as “10 or more and 20 or less”.

### 1. Catalyst A

A catalyst A is a catalyst including: a carbon support doped with a nitrogen atom and a first transition metal atom; and a plurality of fine particles containing a noble metal and supported on the carbon support. The fine particles have an average particle size of 0.8 nm or more and 1.5 nm or less.

### (1) Carbon Support

The carbon support is doped with a nitrogen atom and a first transition metal atom. The “carbon support” may be referred to as “noble metal-free carbon catalyst”, “carbon alloy”, or the like. The presence of the nitrogen atom and the first transition metal atom in the carbon support serves as a starting point for forming ultrafine particles which will be described later. On the other hand, when the nitrogen atom and the first transition metal atom are absent, ultrafine particles are not formed.

The first transition metal atom is at least one selected from the group consisting of scandium (Sc), titanium (Ti), vanadium (V), Cr (chromium), manganese (Mn), iron (Fe), cobalt (Co), nickel (Ni), and copper (Cu).

A doping amount of the nitrogen atom is not particularly limited. The doping amount of the nitrogen atom is preferably 0.1 mass % or more and 20 mass % or less, more preferably 0.5 mass % or more and 15 mass % or less, and still more preferably 1 mass % or more and 10 mass % or less, when a total amount of the carbon support is 100 mass %, from the viewpoint of accelerating the refinement of the fine particles upon application of a voltage having a potential cycle.

A doping amount of the first transition metal atom is not particularly limited. The doping amount of the first transition metal atom is preferably 0.1 mass % or more and 20 mass % or less, more preferably 0.5 mass % or more and 15 mass % or less, and still more preferably 1 mass % or more and 10 mass % or less, when a total amount of the carbon support is 100 mass %, from the viewpoint of accelerating the refinement of the fine particles upon application of a voltage having a potential cycle.

A nitrogen adsorption specific surface area of the carbon support is not particularly limited. The nitrogen adsorption specific surface area of the carbon support is preferably 50 m²g⁻¹ or more and 2000 m²g⁻¹ or less, and more preferably 150 m²g⁻¹ or more and 800 m²g⁻¹ or less, from the viewpoint of improving the amount of the fine particles supported.

### (2) A Plurality of Fine Particles Containing Noble Metal

The noble metal is not particularly limited. The noble metal used is preferably at least one selected from the group consisting of platinum (Pt), palladium (Pd), rhodium (Rh), gold (Au), silver (Ag), iridium (Ir), and ruthenium (Ru). Among these noble metals, at least one selected from the group consisting of Pt, Rh, Pd, Ir, and Ru is more preferred, and at least one selected from the group consisting of Pt and Pd is further preferred, from the viewpoint of catalytic performance.

A content of the noble metal in the fine particles is not particularly limited, but is preferably 90 mass % or more, more preferably 95 mass % or more, and still more preferably 98 mass % or more. The content of the noble metal may be 100 mass %.

The number of fine particles supported on the carbon support is not particularly limited as long as it is two or more (plural number).

The average particle size of the fine particles is not particularly limited. The average particle size of the fine particles is preferably 0.8 nm or more and 1.5 nm or less, more preferably 1.1 nm or more and 1.4 nm or less, and still more preferably 1.2 nm or more and 1.3 nm or less, from the viewpoint of ensuring high activity.

The average particle size can be determined by the following method (way to determine the average particle size). The synthesized catalyst is observed with a transmission electron microscope (TEM). A TEM photograph is printed out on paper. The fine particles (black circular images) are regarded as spherical, and the length from end to end of each of the fine particles is regarded as diameter. A total of 300 particles are randomly measured from images with several fields of view (3 to 5 fields of view). The average of the diameters of the counted 300 particles is defined as average particle size.

Further, the fine particles preferably have a standard deviation value of 0% or more and 10% or less with respect to the average particle size value. The standard deviation value is calculated by creating a distribution map from the particle sizes of the 300 particles.

### (3) Method for Manufacturing Catalyst A

A method for manufacturing the catalyst A is not particularly limited. A preferred example of the method for manufacturing the catalyst A will be described.

The preferred example of the method for manufacturing the catalyst A includes: a step of mixing a noble metal salt, an alcohol having 1 to 5 carbon atoms, and a support to form a mixture; and a heating step of heating the mixture at a temperature of 150° C. or higher and 800° C. or lower to produce the catalyst A.

### (3.1) Noble Metal Salt

The noble metal contained in the noble metal is not particularly limited, but at least one selected from the group consisting of platinum (Pt), palladium (Pd), rhodium (Rh), gold (Au), silver (Ag), iridium (Ir), and ruthenium (Ru) is preferably used. Among these noble metals, at least one selected from the group consisting of Pt, Rh, Pd, Ir, and Ru is more preferred, and at least one selected from the group consisting of Pt and Pd is further preferred, from the viewpoint of catalytic performance.

As the noble metal salt, at least one selected from the group consisting of hexachloroplatinum (IV) acid hexahydrate (H₂PtCl₆.6H₂O), tetraamminedichloroplatinum (Pt(NH₃)₄Cl₂.xH₂O), platinum bromide (IV) (PtBr₄), and bis(acetylacetonato)platinum (II) ([Pt(C₅H₇O₂)₂]) can preferably be used.

### (3.2) Alcohol Having 1 to 5 Carbon Atoms

As the alcohol having 1 to 5 carbon atoms, at least one selected from the group consisting of methanol, ethanol, propanol, isopropyl alcohol, 1-butanol, 2-butanol, t-butyl alcohol, 1-pentanol, and 3-pentanol can preferably be used. Among these alcohols, ethanol is preferred from the viewpoint of reducing the environmental load.

The amount ratio of the alcohol to the noble metal salt is not particularly limited. The concentration of the noble metal salt in an alcohol solution in which the noble metal salt is dissolved in the alcohol is not particularly limited. The concentration of the noble metal salt is preferably 0.1 mol L⁻¹ or more and 50 mol L⁻¹ or less, more preferably 5 mol L⁻¹ or more and 40 mol L⁻¹, and further preferably 10 mol L⁻¹ or more and 30 mol L⁻¹ or less, from the viewpoint of producing highly active noble metal fine particles having an average particle size of 0.8 nm or more and 1.5 nm or less and a uniform size.

### (3.3) Support

As the support, the above-described carbon support is used.

### (3.4) Mixing Ratio of Support to Alcohol

A mixing ratio of the support to the alcohol is not particularly limited. From the viewpoint of fully blending the support and the alcohol and producing highly active noble metal fine particles having an average particle size of 0.8 nm or more and 1.5 nm or less and a uniform size, the support is preferably mixed at a ratio of 2 mg or more and 200 mg or less, more preferably mixed at a ratio of 10 mg or more and 100 mg or less, and further preferably mixed at a ratio of 30 mg or more and 80 mg or less, per 1 mL of the alcohol.

### (3.5) Mixing

A mixing method is not particularly limited. Pulverization mixing may be performed using a mortar and a pestle. For example, pulverization mixing may be performed using a dry crusher such as a ball mill, a vibration mill, a hammer mill, a roll mill, or a jet mill. For example, mixing may be performed using a mixer such as a ribbon blender, a Henschel mixer, or a V-type blender.

A mixing time is not particularly limited. Mixing is preferably performed until the alcohol volatilizes so that the mixture dries.

### (3.6) Heating

A heating temperature is 150° C. or higher and 800° C. or lower, preferably 150° C. or higher and 400° C. or lower, and more preferably 150° C. or higher and 250° C. or lower, from the viewpoint of producing highly active noble metal fine particles having an average particle size of 0.8 nm or more and 1.5 nm or less and a uniform size.

Heating is preferably performed in an atmosphere of an inert gas. As the inert gas, a rare gas such as argon gas or nitrogen gas can preferably be used. Heating may be performed in air.

### (4) Amount of Noble Metal Supported

The amount of the noble metal supported is not particularly limited, and a required amount of the noble metal may appropriately be supported in response to the target design and the like. From the viewpoint of catalyst performance and cost, the amount of the noble metal supported is preferably 5 parts by mass or more and 70 parts by mass or less, and more preferably 10 parts by mass or more and 50 parts by mass or less, in terms of metal, per 100 parts by mass of the carbon support.

### (5) Effect of Catalyst A

The catalyst A has high performance because the size of fine particles is reduced upon application of a voltage having a potential cycle.

### 2. Catalyst B

A catalyst B is a catalyst including: a carbon support doped with nitrogen and a first transition metal atom; and a plurality of fine particles containing a noble metal and supported on the carbon support. The fine particles include particles having a size of less than 0.8 nm.

### (1) Carbon Support

The description about the “carbon support” in the catalyst B is omitted, since the explanation in the column “1. Catalyst A” is applied as it is. That is, the “carbon support” explained in the column “1. Catalyst A” is applied as it is.

### (2) A Plurality of Fine Particles Containing Noble Metal

The noble metal is not particularly limited. The noble metal used is preferably at least one selected from the group consisting of platinum (Pt), palladium (Pd), rhodium (Rh), gold (Au), silver (Ag), iridium (Ir), and ruthenium (Ru). Among these noble metals, at least one selected from the group consisting of Pt, Rh, Pd, Ir, and Ru is more preferred, and at least one selected from the group consisting of Pt and Pd is further preferred, from the viewpoint of catalytic performance.

A content of the noble metal in the fine particles is not particularly limited, but is preferably 90 mass % or more, more preferably 95 mass % or more, and still more preferably 98 mass % or more. The content of the noble metal may be 100 mass %.

The number of fine particles supported on the carbon support is not particularly limited as long as it is two or more (plural number).

The fine particles include particles having a size of less than 0.8 nm. The presence of the particles having a size of less than 0.8 nm can be confirmed by observing the catalyst with a transmission electron microscope (TEM).

Specifically, the catalyst is observed with a transmission electron microscope (TEM). The TEM photograph is printed out on paper. The noble metal fine particles (black circular images) are regarded as spherical, and the length from end to end of each of the fine particles is regarded as diameter. A total of 300 particles are randomly measured from images with several fields of view (3 to 5 fields of view). When the particles having a size of less than 0.8 nm are present in the total of 300 particles, it is determined that the fine particles include the particles having a size of less than 0.8 nm. The particles having a size of less than 0.8 nm are preferably particles having a size of 0.2 nm or more and less than 0.8 nm, and more preferably particles having a size of 0.3 nm or more and 0.7 nm or less.

The average particle size of the fine particles is not particularly limited. The average particle size of the fine particles is preferably 0.2 nm or more and 1.5 nm or less, from the viewpoint of ensuring high activity.

The average particle size can be determined by the following method (way to determine the average particle size). The synthesized catalyst is observed with a transmission electron microscope (TEM). A TEM photograph is printed out on paper. The fine particles (black circular images) are regarded as spherical, and the length from end to end of each of the fine particles is regarded as diameter. A total of 300 particles are randomly measured from images with several fields of view (3 to 5 fields of view). The average of the diameters of the counted 300 particles is defined as average particle size.

The fine particles preferably have at least one peak at less than 0.8 nm in a particle size distribution map. The distribution map is created from the particle sizes of 300 particles.

### (3) Method for Manufacturing Catalyst B

A method for manufacturing the catalyst B is not particularly limited. A preferred example of the method for manufacturing the catalyst B will be described.

The catalyst B can be suitably manufactured by applying, under an acidic environment, a voltage having a potential cycle to a composite in which a plurality of raw material fine particles containing a noble metal are supported on a carbon support doped with a nitrogen atom and a first transition metal atom to dissolve and make minute (reduce in size) at least one of the raw material fine particles; and generating new fine particles, on the carbon support, from metal ions generated by the dissolution. The catalyst A described above can be used as the composite in which a plurality of raw material fine particles containing a noble metal are supported on a carbon support doped with nitrogen and a first transition metal atom. Therefore, the catalyst B can be suitably manufactured by, after manufacture of the catalyst A described above, applying a voltage having a potential cycle under an acidic environment to dissolve and make minute at least one of raw material fine particles (fine particles having an average particle size of 0.8 nm or more and 1.5 nm or less in the catalyst A), and generating new fine particles, on the carbon support, from metal ions generated by the dissolution.

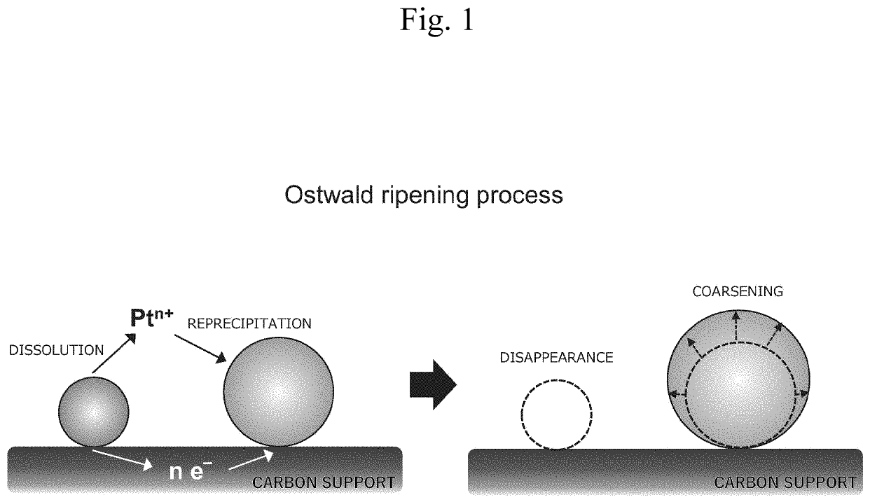

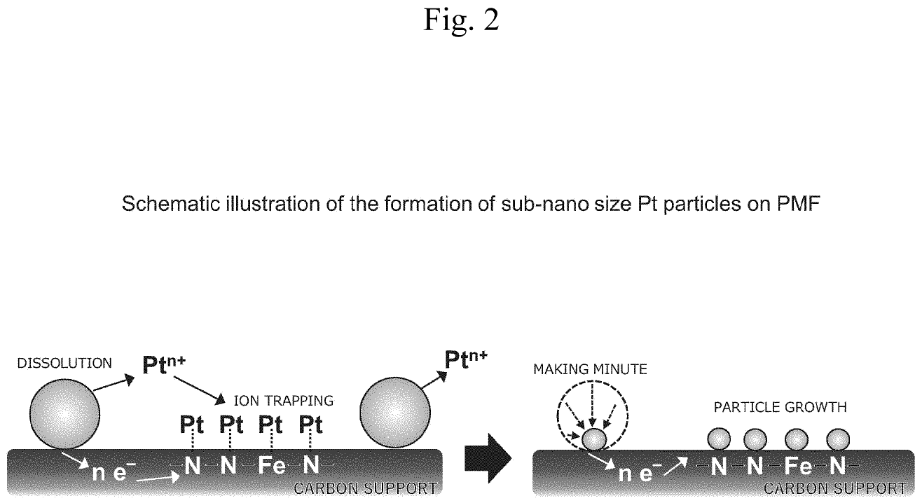

Here, an estimated mechanism by which fine particles in the sub-nano region (1 nm or less) are formed by the method for manufacturing the catalyst B will be described with reference to FIGS. 1 and 2. Pt particles are exemplified as the fine particles containing a noble metal.

FIG. 1 illustrates a case where a carbon support doped with neither a nitrogen atom nor a first transition metal atom is used. The left diagram of FIG. 1 illustrates a composite in which Pt particles (raw material fine particles) are supported. When a voltage having a potential cycle is applied to the composite under an acidic environment, for example, Pt particles having a size of 1.4 nm to 2 nm are dissolved to form Ptⁿ⁺, and Ptⁿ⁺ is reprecipitated on the adjacent Pt particles, which are coarsened, as illustrated in the right diagram. That is, when a carbon support doped with neither a nitrogen atom nor a first transition metal atom is used, Pt particles are usually coarsened by Ostwald ripening.

FIG. 2 illustrates a case where a carbon support doped with a nitrogen atom and a first transition metal atom is used. The left diagram of FIG. 2 illustrates a composite in which Pt particles (raw material fine particles) are supported. When a voltage having a potential cycle is applied to the composite under an acidic environment, the Pt particles are dissolved to form Ptⁿ⁺. The dissolved Ptⁿ⁺ is trapped by the nitrogen atom (N atom) or an Fe atom (an example of the first transition metal atom) on the support before reaching the adjacent Pt particles to form new Pt particles. At the same time, the remaining Pt particles also become small, both the new particles and the remaining particles become sub-nano sized (ultrafine particles), and a catalyst exhibiting a high specific surface area and high activity is presumed to be obtained.

A composite in which a plurality of raw material fine particles containing a noble metal is supported on a carbon support doped with a nitrogen atom and a first transition metal atom will be described. This composite corresponds to the “catalyst A” described above. Thus, the composite can be manufactured by the above “(3) Method for manufacturing catalyst A”.

The “acidic environment” is not particularly limited. Specifically, immersion of the composite in an acid solution and contact thereof with an acid solution are exemplified. The acid solution is not particularly limited. The acid solution is preferably, for example, a perchloric acid solution, from the viewpoint of dissolving and making minute at least one of the fine particles and facilitating generation of new fine particles, on the carbon support, from metal ions generated by the dissolution.

The potential cycle includes repetition of a low potential and a high potential.

Based on a standard hydrogen electrode, the low potential is preferably 0.0 V or more and 0.7 V or less, and more preferably 0.5 V or more and 0.7 V or less.

Based on the standard hydrogen electrode, the high potential is preferably 0.8 V or more and 1.2 V or less, and more preferably 0.9 V or more and 1.1 V or less.

For example, a potential cycle between 0.0 V and 1.0 V is preferred, and a potential cycle between 0.6 V and 1.0 V is more preferred, based on the standard hydrogen electrode.

When the low potential and the high potential are set to these preferred ranges, the fine particles are dissolved to form sub-nano size ultrafine particles, and the new fine particles also become sub-nano size ultrafine particles.

A low potential time per cycle is not particularly limited. The low potential time is preferably 0.5 seconds or more and 300 seconds or less, more preferably 1 second or more and 60 seconds or less, and still more preferably 3 seconds or more and 10 seconds or less, from the viewpoint of forming ultrafine particles.

A high potential time per cycle is not particularly limited. The high potential time is preferably 0.5 seconds or more and 300 seconds or less, more preferably 1 second or more and 60 seconds or less, and still more preferably 3 seconds or more and 10 seconds or less, from the viewpoint of an appropriate amount of Pt dissolved.

A waveform of the potential cycle is not particularly limited. Examples of the waveform include a pulse wave, a periodic waveform, a rectangular wave, a triangular wave, and a sine wave.

The number of potential cycles is not particularly limited. The number of potential cycles is preferably 1 or more and 100,000 or less, more preferably 10 or more and 50,000 or less, and still more preferably 100 or more and 10,000 or less, from the viewpoint of forming sub-nano size ultrafine particles and improving the catalyst performance.

### (4) Amount of Noble Metal Supported

The amount of the noble metal supported is not particularly limited, and a required amount of the noble metal may appropriately be supported in response to the target design and the like. From the viewpoint of catalyst performance and cost, the amount of the noble metal supported is preferably 5 parts by mass or more and 70 parts by mass or less, and more preferably 10 parts by mass or more and 50 parts by mass or less, in terms of metal, per 100 parts by mass of the carbon support.

### (5) Effect of Catalyst B

The catalyst B contains sub-nanoparticles and has high performance.

### 3. Catalyst C

A catalyst C is a catalyst obtained by: applying, under an acidic environment, a voltage having a potential cycle to a composite in which a plurality of raw material fine particles containing a noble metal are supported on a carbon support doped with a nitrogen atom and a first transition metal atom to dissolve and make minute at least one of the raw material fine particles; and generating new fine particles, on the carbon support, from metal ions generated by the dissolution.

### (1) Carbon Support

The description about the “carbon support” in the catalyst C is omitted, since the explanation in the column “1. Catalyst A” is applied as it is. That is, the “carbon support” explained in the column “1. Catalyst A” is applied as it is.

### (2) A Plurality of Raw Material Fine Particles Containing Noble Metal

The description about the “plurality of raw material fine particles containing a noble metal” in the catalyst C is omitted, since the explanation in “(2) A plurality of fine particles containing noble metal” of the column “1. Catalyst A” is applied as it is while the wording “fine particles” used in the explanation is replaced with “raw material fine particles”.

### (3) Application of Voltage Having Potential Cycle Under Acidic Environment

The description about the application of a voltage having a potential cycle under an acidic environment is omitted, since the explanation in the column describing “(3) Method for manufacturing catalyst B” of “2. Catalyst B” is applied as it is.

### (4) Amount of Noble Metal Supported

The amount of the noble metal supported is not particularly limited, and a required amount of the noble metal may appropriately be supported in response to the target design and the like. From the viewpoint of catalyst performance and cost, the amount of the noble metal supported is preferably 5 parts by mass or more and 70 parts by mass or less, and more preferably 10 parts by mass or more and 50 parts by mass or less, in terms of metal, per 100 parts by mass of the carbon support.

### (5) Effect of Catalyst C

The catalyst C contains sub-nanoparticles and has high performance.

### 4. Application of Catalysts A, B and C

The catalysts A, B, and C can be applied to a fuel cell. The potential cycle that is one of sub-nanoparticle formation conditions described in “(3) Method for manufacturing catalyst B” corresponds to an operating potential range in a fuel cell. In particular, in consideration of use in a fuel cell vehicle (FCV), it matches a potential fluctuation range at the time of load fluctuation of the FCV. That is, the catalysts A, B, and C are mounted on a fuel cell, so that highly active sub-nanoparticle catalysts are self-formed due to the operation, and the activity continues indefinitely, that is, high durability is exhibited. As a result, innovative catalysts are obtained, which realize both improvement in activity and maintenance of durability, which are problems of fuel cells.

In the case of the catalyst A, the average particle size of the fine particles is 0.8 nm or more and 1.5 nm or less in the initial state, but, when the catalyst A is mounted on the fuel cell, the particle size decreases due to the operation, and then a highly active sub-nanoparticle catalyst is self-formed, and the activity continues indefinitely.

In the case of the catalysts B and C, they are highly active sub-nanoparticle catalysts even in the initial state, and, when the catalysts B and C are mounted on a fuel cell, highly active sub-nanoparticle catalysts are self-formed due to the operation, and the activity continues indefinitely.

### 5. Electrode

An electrode including the catalyst may be used as a cathode, as an anode, or both as a cathode and as an anode.

The electrode of the present disclosure has sub-nanoparticles contained in the catalyst and thus has high performance.

### 6. Membrane Electrode Assembly

A membrane electrode assembly includes the electrode on a surface of an electrolyte membrane.

The membrane electrode assembly of the present disclosure has sub-nanoparticles contained in the catalyst and thus has high performance.

### 7. Fuel Cell

A fuel cell includes the catalyst. Examples of the fuel cell can include a polymer electrolyte fuel cell (PEFC), a phosphoric acid fuel cell (PAFC), a molten carbonate fuel cell (MCFC), a solid oxide fuel cell (SOFC), an alkaline electrolyte fuel cell (AFC), and a direct fuel cell (DFC). The fuel cell of the present disclosure has sub-nanoparticles contained in the catalyst and thus has high performance.

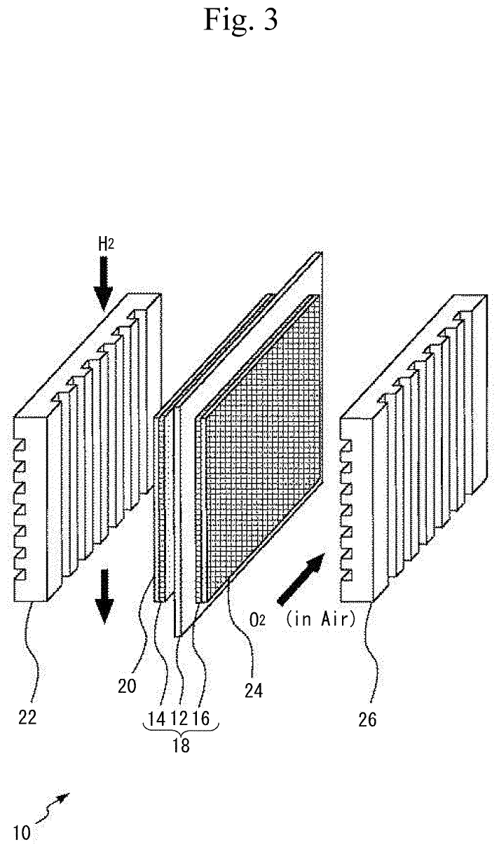

A configuration example of the fuel cell will be described. This fuel cell 10 is a polymer electrolyte fuel cell as a suitable example. As shown in FIG. 3, the fuel cell 10 includes a polymer electrolyte membrane 12 as an electrolyte membrane. The polymer electrolyte membrane 12 is made of, for example, a perfluorosulfonic acid resin. On both sides of the polymer electrolyte membrane 12, an anode electrode 14 and a cathode electrode 16 are provided so as to sandwich the polymer electrolyte membrane 12. The polymer electrolyte membrane 12 and a pair of the anode electrode 14 and the cathode electrode 16 sandwiching the polymer electrolyte membrane 12 constitute a membrane electrode assembly 18.

A gas diffusion layer 20 is provided outside the anode electrode 14. The gas diffusion layer 20 is made of a porous material such as carbon paper, carbon cloth, or a metal porous body, and has a function of uniformly diffusing a gas supplied from a separator 22 side into the anode electrode 14. Similarly, a gas diffusion layer 24 is provided outside the cathode electrode 16. The gas diffusion layer 24 has a function of uniformly diffusing a gas supplied from a separator 26 side into the cathode electrode 16. Although only one set of the membrane electrode assembly 18, the gas diffusion layers 20 and 24, and the separators 22 and 26 configured as described above is shown in this figure, the actual fuel cell 10 may have a stack structure in which a plurality of membrane electrode assemblies 18 and gas diffusion layers 20 and 24 are stacked with the separators 22 and 26 interposed therebetween.

### 8. Method for Manufacturing Catalyst

A method for manufacturing a catalyst of the present disclosure includes: applying, under an acidic environment, a voltage having a potential cycle to a composite in which a plurality of raw material fine particles containing a noble metal are supported on a carbon support doped with a nitrogen atom and a first transition metal atom to dissolve and make minute at least one of the raw material fine particles; and generating new fine particles, on the carbon support, from metal ions generated by the dissolution.

### (1) Carbon Support

The description about the “carbon support” in the manufacture method is omitted, since the explanation in the column “1. Catalyst A” is applied as it is. That is, the “carbon support” explained in the column “1. Catalyst A” is applied as it is.

### (2) A Plurality of Raw Material Fine Particles Containing Noble Metal

The description about the “plurality of raw material fine particles containing a noble metal” in the manufacture method is omitted, since the explanation in “(2) A plurality of fine particles containing noble metal” of the column “1. Catalyst A” is applied as it is while the wording “fine particles” used in the explanation is replaced with “raw material fine particles”.

### (3) Application of Voltage Having Potential Cycle Under Acidic Environment

The description about the application of a voltage having a potential cycle under an acidic environment is omitted, since the explanation in the column describing “(3) Method for manufacturing catalyst B” of “2. Catalyst B” is applied as it is.

### (4) Effect of Manufacture Method

In the present manufacture method, sub-nanoparticles are formed, and a high-performance catalyst can be manufactured.

### EXAMPLES

The present disclosure will be described more specifically by way of Examples.

### 1. Type of Carbon Support

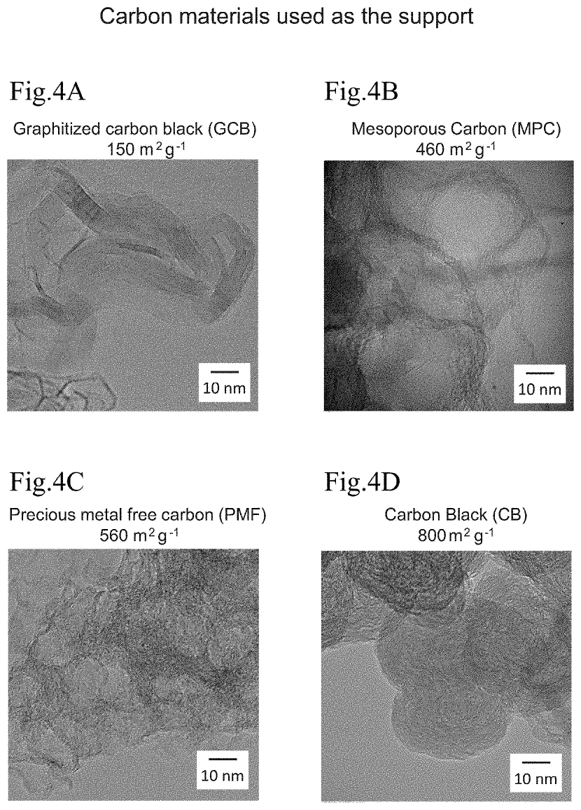

In order to examine an influence of the type of carbon support loaded with Pt (surface area, structure, defect, and the like), four types of carbon supports were prepared. FIGS. 4A to 4D illustrate electron micrographs (TEM images) of the four types of carbon supports comparatively studied.

FIG. 4A illustrates a graphitized carbon black (GCB) having the smallest specific surface area of 150 m²g⁻¹. It advantageously has high resistance because graphene has grown into multiple layers on the carbon surface.

FIG. 4B illustrates a general mesoporous carbon (MPC) having a specific surface area of 460 m²g⁻¹.

FIG. 4C illustrates a carbon alloy (N—Fe—C, precious metal free carbon (PMF)) in which a carbon skeleton of mesoporous carbon is doped with a nitrogen atom (N) and an iron atom (Fe), the carbon alloy having a specific surface area of 560 m²g⁻¹.

FIG. 4D illustrates carbon black ((CB), Ketjen black) having a specific surface area of 800 m²g⁻¹. All of these carbons are commercially available products.

### 2. Support of Pt

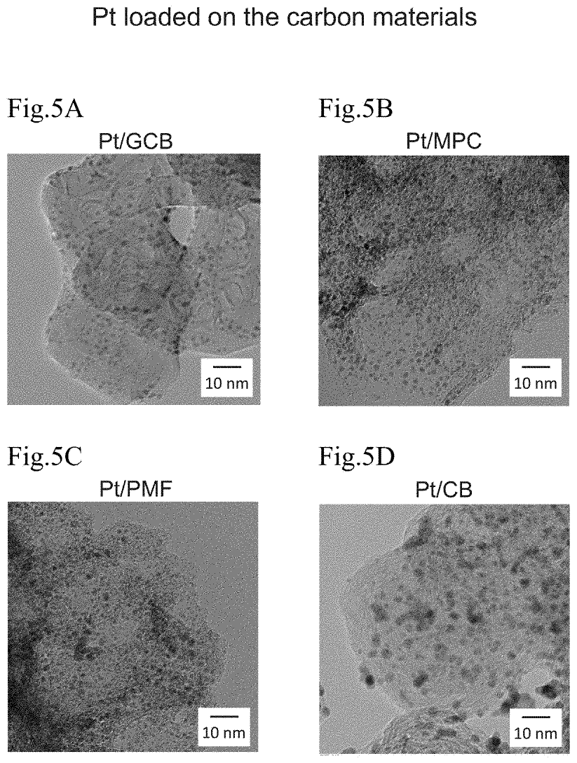

FIGS. 5A to 5D illustrate electron micrographs (TEM images) after Pt is loaded on each of the carbon supports illustrated in FIGS. 4A to 4D. FIGS. 5A, 5B, 5C and 5D correspond to FIGS. 4A, 4B, 4C, and 4D, respectively. “Pt/GCB” refers to graphitized carbon black loaded with Pt. “Pt/MPC” refers to mesoporous carbon loaded with Pt. “Pt/PMF” refers to a carbon alloy doped with a nitrogen atom (N) and an iron atom (Fe) and loaded with Pt. “Pt/CB” refers to carbon black loaded with Pt. Only Pt/CB in FIG. 5D is a commercially available product, and the others are loaded with Pt according to the prior art (paragraph [0040] of Japanese Patent Application No. 2019-227955). Although the Pt nanoparticles of FIGS. 5A, 5B, and 5C are smaller than the commercially available Pt/CB of FIG. 5D, all of the Pt nanoparticles are successfully dispersed and supported.

FIGS. 5A, 5B, and 5C were specifically prepared as follows. That is, hexachloroplatinic (IV) acid hexahydrate (H₂PtCl₆.6H₂O: Kanto Chemical Co., Inc., 98.5%) was collected in a 60 mg beaker, and 1 mL of ethanol (C₂H₅OH) was added thereto to dissolve hexachloroplatinic (IV) acid hexahydrate. After collection of 45 mg of a carbon support in a mortar, an ethanol solution in which the above Pt salt was dissolved was added thereto, and the mixture was stirred and mixed until ethanol volatilized to dryness. The obtained powder was transferred to a ceramic boat and heat-treated in an argon (Ar) atmosphere at 200° C. for 2 hours in a tubular furnace. After the temperature was lowered to room temperature, the heat-treated powder was taken out from the tubular furnace and used as a catalyst.

3. Formation of Each Carbon Support Loaded with Pt into Electrode

Each carbon support loaded with Pt was formed into an electrode. A procedure is as follows. Each carbon support loaded with a specified amount (2 mg) of Pt was dispersed in ethanol, and fixed, in a dispersed state, on a disk-shaped carbon electrode substrate. After drying, a 0.2% Nafion solution was added dropwise so as to attain a dry membrane thickness of 0.1 μm, and vacuum drying was performed.

### 4. Potential Cycle Treatment

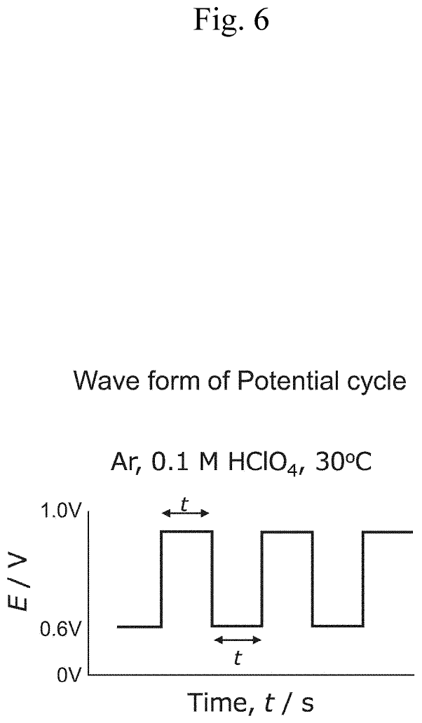

Next, the prepared electrode was immersed in an Ar-degassed 0.1 M HClO₄ solution, and connected to a potentiostat as a working electrode. A Pt wire and a saturated hydrogen electrode (RHE) were used as a counter electrode and a reference electrode, respectively. Thereafter, the potential cycle was repeated a specified number of times (0 to 100,000 times) with the waveform illustrated in FIG. 6. Hereinafter, this treatment may be referred to as “potential cycle treatment”.

The waveform illustrated in FIG. 6 has a low potential of 0.6 V and a high potential of 1.0 V based on the standard hydrogen electrode. In addition, the low potential time in one cycle is 3 seconds, the high potential time is 3 seconds, and one cycle is 6 seconds.

### 5. TEM Image and Change in Particle Size Distribution Before and After Potential Cycle Treatment

### (1) Case of Pt/GCB and the Like

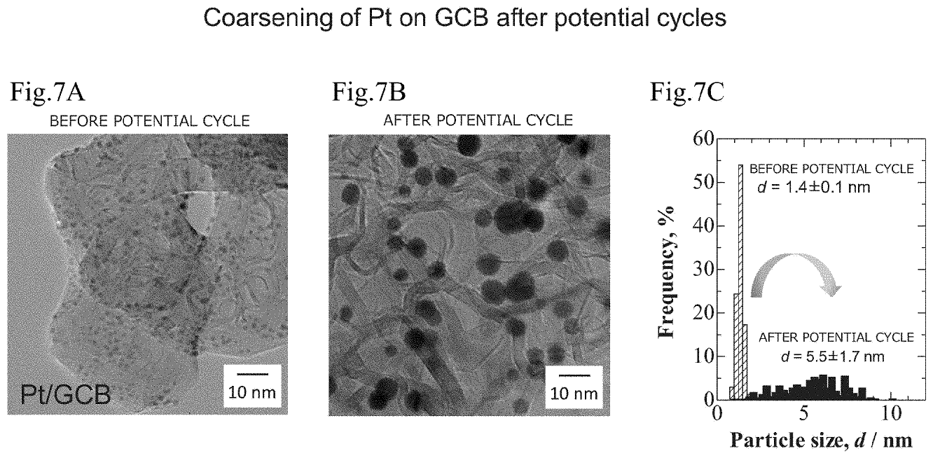

FIGS. 7A and 7B illustrate TEM images of Pt/GCB before and after the potential cycle treatment. FIG. 7C illustrates a change in particle size distribution of Pt particles in Pt/GCB before and after the potential cycle treatment. In the case of Pt/GCB, the average particle size (d) and its standard deviation value (±σ) were 1.4±0.1 nm before the potential cycle treatment, but increased to 5.5±1.7 nm after the potential cycle, and the distribution width was considerably wide. In addition, the same phenomenon was observed in the case of Pt/MPC and Pt/CB. It is considered that these phenomena were observed because Ostwald ripening occurred in which Pt particles dissolved during the potential cycle treatment were reprecipitated on the adjacent Pt particles, which were coarsened (see FIG. 1).

### (2) Case of Pt/PMF

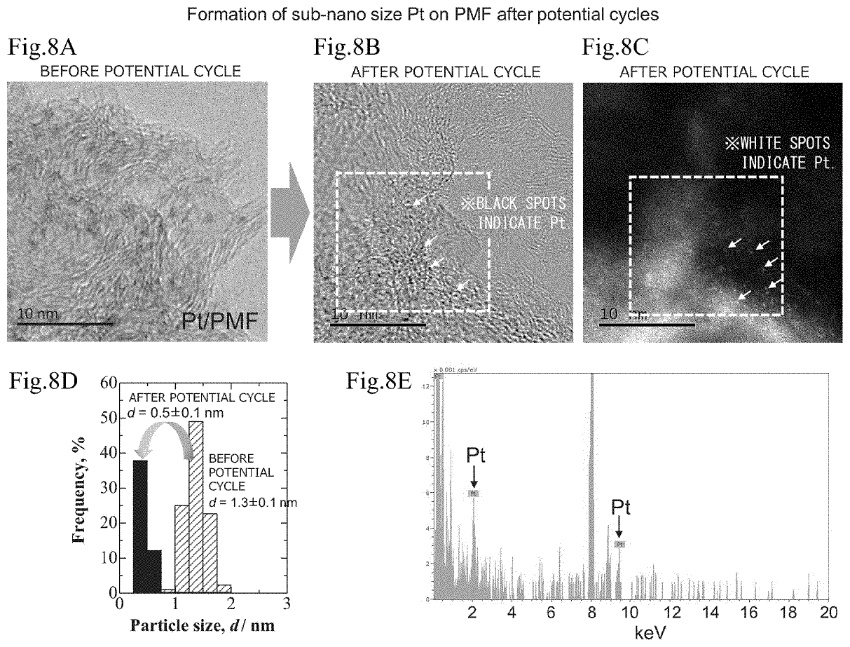

In the case of Pt/PMF, as illustrated in FIGS. 8A to 8E, as compared with the distribution state of Pt particles before the potential cycle treatment (see FIG. 8A), black spots minuter than the initial Pt particles could be confirmed after the potential treatment (see FIG. 8B). The black spots clearly appeared as white light spots as a heavy element in the dark field image (see FIG. 8C). Further, it could be confirmed, from the energy dispersive X-ray analysis (EDX), that these minute points were Pt particles (see FIG. 8E). That is, it was found that the ultrafine particles appearing on the PMF after the potential cycle treatment were Pt particles. When the change in particle size distribution was confirmed, the Pt size was 1.3±0.1 nm before the potential cycle treatment, but was changed to 0.5±0.1 nm after the potential cycle treatment (see FIG. 8D). The carbon support largely differs from the other carbon supports in that the carbon skeleton is doped with an N atom and an Fe atom. Therefore, in the case of Pt/PMF, as illustrated in FIG. 2, Pt ions dissolved during the potential cycle treatment are trapped by the N or Fe atom on the carbon before reaching the adjacent Pt particles. It is presumed that nuclear growth occurs there, resulting in formation of new ultrafine particles. Further, the Pt particles (nanoparticles) as a matrix are reduced in volume by dissolution, and are also reduced in size to 0.5 nm (sub-nano size). Not all the original particles are refined, and there are also some particles coarsening like Pt/GCB. However, it is considered that the catalyst exhibits a positive performance as a whole (see the following evaluation of catalytic activity).

### 6. Evaluation of Catalytic Activity

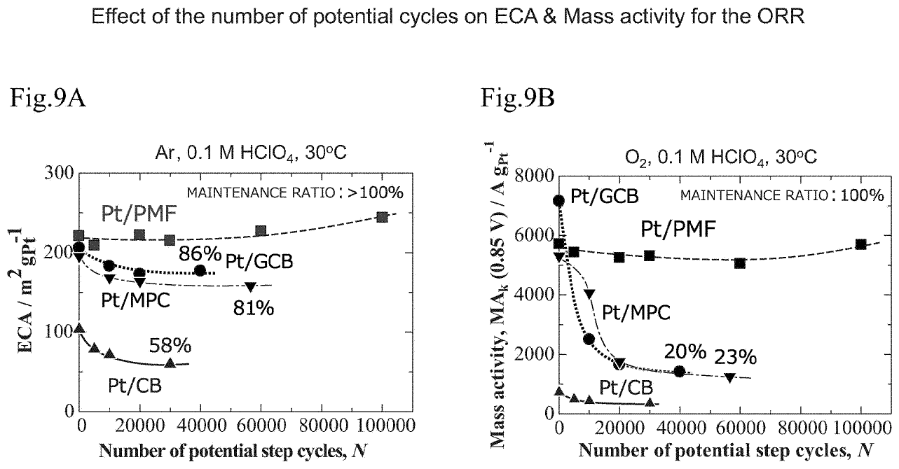

The catalytic activity was evaluated using the electrode after the potential cycle treatment. FIG. 9A is a plot of the electrochemical surface area (ECA) of each catalyst acquired in an Ar-degassed 0.1 M HClO₄ solution against the number of cycles of the potential cycle treatment. FIG. 9B is a plot of the mass activity value (current value per g of platinum) of the oxygen reduction reaction in the same solution saturated with oxygen against the number of cycles of the potential cycle treatment. In all of Pt/GCB, Pt/MPC, and Pt/CB, the ECA value decreases as the number of potential cycle treatments increases. This is presumed to be due to coarsening of the Pt particles due to Ostwald ripening. As the ECA decreases, the mass activity also decreases, resulting in attenuation of the catalytic ability. On the other hand, in Pt/PMF, the ECA tends to slightly increase from a constant value with respect to the number of cycles, suggesting that the refined Pt particles act as a catalyst. In Pt/PMF, the ECA value does not decrease and therefore the mass activity also does not decrease.

### 7. Influence of Pt Supporting Method

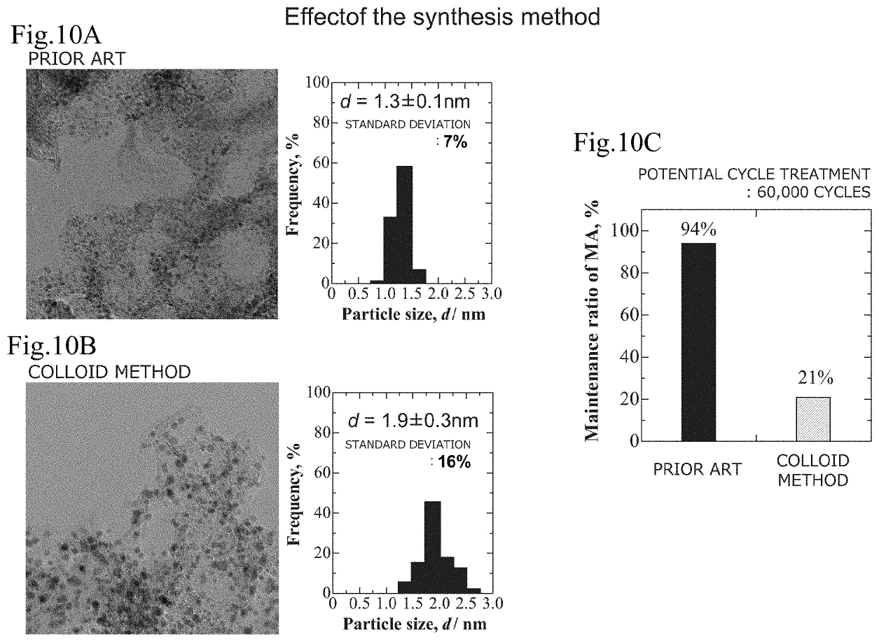

The influence by the Pt supporting method was examined. FIGS. 10A and 10B illustrate TEM images and particle size distributions of Pt/PMF synthesized by the prior art (the technique of Japanese Patent Application No. 2019-227955) and Pt/PMF synthesized by a general colloid method. In the prior art, the characteristics of the synthesis method are utilized, and the particle size is uniform. The standard deviation was only 7% of the average particle size (see FIG. 10A). On the other hand, the standard deviation value in the colloid method is 16% of the average particle size, showing a wide distribution width (FIG. 10B). When two types of Pt/PMF different in distribution width were subjected to a potential cycle treatment in the same manner as in the above “4. Potential cycle treatment” and the catalytic activities were compared, it was found that, in the case of Pt/PMF synthesized by the prior art (the technique of Japanese Patent Application No. 2019-227955), the maintenance ratio of the activity is extremely high even when the potential cycle treatment is large (FIG. 10C). In this experiment, the electrodes after 60,000 cycles of the potential cycle treatment were used.

From the experimental results, it was found that, when Pt/PMF prepared through a step of mixing a noble metal salt, an alcohol having 1 to 5 carbon atoms, and a support to form a mixture; and a heating step of heating the mixture at a temperature of 150° C. or higher and 800° C. or lower to produce a catalyst, as in the prior art, was used, the catalyst has an extremely high maintenance ratio rate of the catalytic activity even after repeated use.

### 8. Others

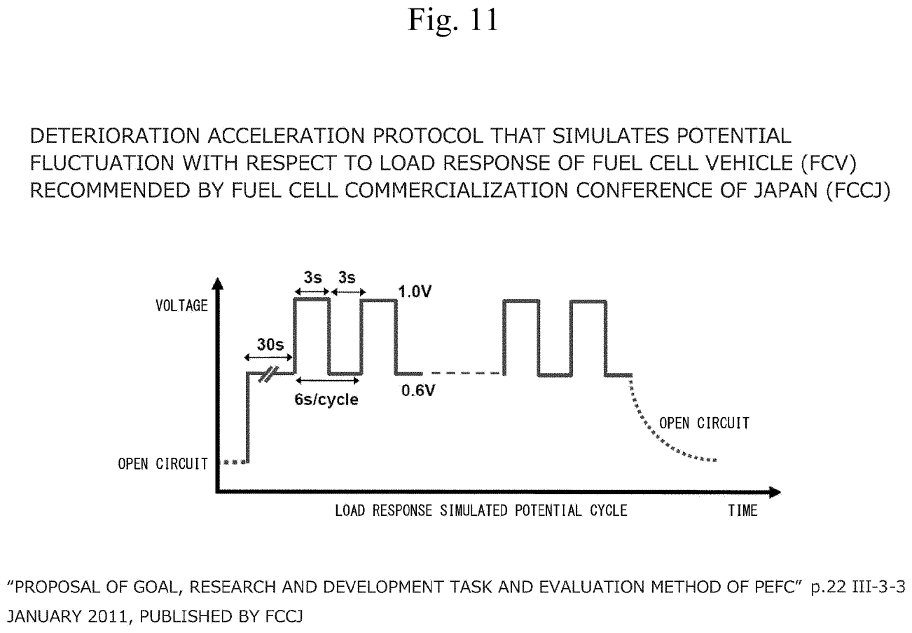

FIG. 11 illustrates a deterioration acceleration protocol that simulates a potential fluctuation with respect to a load response of a fuel cell vehicle (FCV) recommended by Fuel Cell Commercialization Conference of Japan (FCCJ). As a result, it is recommended to evaluate durability by accelerating deterioration of a platinum catalyst, as a domestic evaluation standard. It can be seen that this protocol shows a rectangular wave retaining the respective potentials of 0.6 V and 1.0 V for 3 seconds. Namely, this is similar to the potential cycle treatment proposed in the present disclosure (see FIG. 6), and each potential and retention time are also within the condition ranges. That is, the application of the present disclosure to a fuel cell for FCV provides a catalyst in which sub-nano Pt particles are spontaneously formed in the cell, and its performance is not deteriorated. That is, the catalyst is substantially not deteriorated in appearance.

### 9. Effect of the Present Embodiment

The present embodiment is very important in terms of cost reduction for fuel cells. The present embodiment is expected to greatly contribute to the spread of fuel cells themselves, the spread of fuel cell vehicles using the fuel cells, and the acceleration of the spread of stationary cogeneration.

It is noted that the foregoing examples have been provided merely for the purpose of explanation and are in no way to be construed as limiting of the present disclosure. While the present disclosure has been described with reference to exemplary embodiments, it is understood that the words which have been used herein are words of description and illustration, rather than words of limitation. Changes may be made, within the scope of the appended claims, without departing from the scope and spirit of the present disclosure in its aspects. Although the present disclosure has been described herein with reference to particular structures, materials and embodiments, the present disclosure is not intended to be limited to the particulars disclosed herein; rather, the present disclosure extends to all functionally equivalent structures, methods and uses, which are within the scope of the appended claims.

The present disclosure is not limited to the embodiments described in detail above, and can be modified or changed in various manners within the scope as set forth in the claims.

What is claimed is:

1. A catalyst comprising: A carbon support doped with a nitrogen atom and a first transition metal atom; and a plurality of fine particles containing a noble metal and supported on the carbon support, wherein
the fine particles have an average particle size of 0.8 nm or more and 1.5 nm or less.

2. The catalyst according to claim 1, wherein the fine particles have a standard deviation value of 0% or more and 10% or less with respect to an average particle size value.

3. The catalyst according to claim 1, wherein, when the catalyst is used in a fuel cell, at least one of the fine particles is dissolved and made minute due to power generation, and new fine particles containing a noble metal are generated on the carbon support from metal ions generated by the dissolution.

4. An electrode comprising the catalyst according to claim 1.

5. A membrane electrode assembly comprising the electrode according to claim 4 on a surface of an electrolyte membrane.

6. A fuel cell comprising the catalyst according to claim 1.

7. A catalyst comprising: A carbon support doped with a nitrogen atom and a first transition metal atom; and a plurality of fine particles containing a noble metal and supported on the carbon support, wherein
the fine particles comprise particles having a size of less than 0.8 nm.

8. The catalyst according to claim 7, wherein the fine particles have at least one peak at less than 0.8 nm in a particle size distribution map.

9. A catalyst obtained by: Applying, under an acidic environment, a voltage having a potential cycle to a composite in which a plurality of raw material fine particles containing a noble metal are supported on a carbon support doped with a nitrogen atom and a first transition metal atom to dissolve at least one of the raw material fine particles and make the particles minute; and generating new fine particles, on the carbon support, from metal ions generated by the dissolution.

10. The catalyst according to claim 9, wherein the potential cycle is a cycle repeated between potentials of 0 V or more and 1.0 V or less based on a standard hydrogen electrode.

11. An electrode comprising the catalyst according to claim 7.

12. A membrane electrode assembly comprising the electrode according to claim 11 on a surface of an electrolyte membrane.

13. A fuel cell comprising the catalyst according to claim 7.

14. A method for manufacturing a catalyst, comprising: Applying, under an acidic environment, a voltage having a potential cycle to a composite in which a plurality of raw material fine particles containing a noble metal are supported on a carbon support doped with a nitrogen atom and a first transition metal atom to dissolve at least one of the raw material fine particles and make the particles minute; and generating new fine particles, on the carbon support, from metal ions generated by the dissolution.

15. The method for manufacturing a catalyst according to claim 14, wherein the potential cycle is a cycle repeated between potentials of 0 V or more and 1.0 V or less based on a standard hydrogen electrode.
